(19) United States
(12) Patent Application Publication
(10) Pub. No.: US 2013/0340418 A1
(43) Pub. Date: Dec. 26, 2013

(54) Energy Storage Cylinder and Control System for a Moving Structural Member

(71) Applicants: Gang Victor Wen, Dunlap, IL (US); Pengfei Ma, Naperville, IL (US); Jiao Zhang, Naperville, IL (US)

(72) Inventors: Gang Victor Wen, Dunlap, IL (US); Pengfei Ma, Naperville, IL (US); Jiao Zhang, Naperville, IL (US)

(73) Assignee: CATERPILLAR, INC., Peoria, IL (US)

(21) Appl. No.: 13/529,387

(22) Filed: Jun. 21, 2012

(51) Int. Cl. F15B 1/02; F15B 15/14

(52) U.S. Cl. 60/327; 91/5; 60/477

(57) ABSTRACT

An energy storage system is disclosed for use in a hydraulic system for moving a structural member such as a boom assembly. The system features at least one work cylinder and an additional energy storage cylinder that assists in raising and lowering functions by storing and withdrawing pressurized fluid from an accumulator. The pressurized fluid in the accumulator may be used for raising operations as well as digging and tamping operations. Further, the energy recovery features may be selectively disconnected during either a raising or lowering operation.

### TECHNICAL FIELD

The disclosure is directed to an energy storage and regeneration circuit and control logic therefore. For example, the concepts of this disclosure can be applied to an energy conservation system that is installed on an earth-moving/loading machine having a boom assembly.

### BACKGROUND

Hydraulic excavators and wheel loaders are typical earth-moving and loading machines that are designed and constructed to dig, raise, and/or carry heavy payloads of dirt, rocks, sand and/or construction materials. Such earth-moving loading machines commonly have a boom assembly that connects the base of the machine to a bucket or shovel. The boom assembly is raised and lowered by at least one hydraulic cylinder, which are controlled by a series of hydraulic valves. Energy in the form of pressurized fluid is provided to the hydraulic cylinder by a diesel or electric powered pump or hydraulic motor.

In operation, an earth-moving/loading machine cycles through a series of operations to dig, raise, and transfer a load. First, the operator of the loading machine lowers the bucket and then pushes and curls the bucket into a pile of fractured earth or material. The bucket is manipulated by the operator to obtain a full payload. Using the machine's hydraulic power, the boom hoist cylinders are filled with pressurizing fluid, raising the boom assembly and bucket to the desired height, which typically may be a height sufficient to clear the side rail of a truck being loaded. The operator then moves the bucket to a desired position and dumps the contents of the payload. The boom assembly is returned to a position for acquiring another payload. The operator opens the hydraulic control valves, allowing the hydraulic fluid to escape from the boom hoist cylinder, and causing the boom assembly and bucket to return to the lowered position under the force of their own weight. This cycle is then repeated.

The hydraulic forces required to raise the boom assembly are substantial. Conventional hydraulic systems, however, are relatively inefficient. Specifically, every time the machine dumps its payload from the raised position, the operator opens a hydraulic valve, releasing the pressurized hydraulic fluid and allowing it to flow back to the associated hydraulic reservoir, thereby lowering the boom assembly. In so doing, the potential energy stored through the raising of the boom assembly is lost as the pressurized fluid is returned to the unpressurized reservoir.

To remedy this situation, energy storage cylinders have been developed that are pressurized when the boom assembly is lowered. For example, see U.S. Patent Application Publication No. 2010/0018195. However, while such energy storage cylinders have proven useful, there is a need for improved hydraulic circuits and control logics to enable the energy to be more efficiently captured and reused thereby increasing the efficiency of the entire hydraulic system.

### SUMMARY OF THE DISCLOSURE

In one aspect, an energy storage system for assisting and vertically moving the structural member is disclosed. The system may include at least one work cylinder to vertically move the structural member. The system may also include an energy storage cylinder coupled to the structural member. The energy storage cylinder may include a rod end and a cap end, wherein the rod end and cap end may be in selective communication with each other. The system may also include an accumulator, a fluid reservoir and a first valve disposed between the accumulator and the cap end of the storage cylinder. The system may also include a second valve disposed between the fluid reservoir and the cap end of the energy storage cylinder. When the structural member is lowered and the first valve is at least partially opened and the second valve is at least partially closed, at least a portion of the fluid from the cap end of the energy storage cylinder may be directed to the accumulator. Further, when the structural member is raised and the first valve is at least partially open and the second valve is at least partially closed, at least a portion of the fluid from the accumulator may be directed to the cap end of the energy storage cylinder.

In another aspect, a machine is disclosed that raises and lowers a structural member. The machine may include a work cylinder that may include a rod end, a cap end and a piston disposed therebetween. A rod may couple the piston to the structural member. The cap end and rod end of the work cylinder may be in communication with a main control valve for raising or lowering the structural member. The machine may also include an energy storage cylinder that may include a rod end, a cap end and a piston disposed therebetween. The piston of the energy storage cylinder may be connected to an assist rod that is coupled to the structural member. The cap and rod ends of the energy storage cylinder may be in communication with a first valve disposed between the energy storage cylinder and the accumulator. The cap and rod ends of the energy storage cylinder may also be in communication with a second valve disposed between the energy storage cylinder and the reservoir. The rod end of the energy storage cylinder may be in selective communication with the cap end of the energy storage cylinder. When the structural member is lowered, fluid flows from the cap end of the energy storage cylinder through the first valve to the accumulator. Further, when the structural member is raised, fluid flows from the accumulator to the cap end of the energy storage cylinder through the first valve.

In another aspect, a method for controlling a raising and a lowering of a structural member is disclosed. The method may include providing a work cylinder including a rod end, a cap end and a piston disposed therebetween with a rod coupling the piston to the structural member. The cap end and rod end of the work cylinder may be in communication with a main control valve for raising or lowering the structural member. The method may also include providing an energy storage cylinder. The energy storage cylinder may include a rod end, a cap end and a piston disposed therebetween with a piston being connected to the structural member by an assist rod. The cap and rod ends of the energy storage cylinder may be in communication with a first valve that provides selective communication between the energy storage cylinder and an accumulator. Wherein, to lower the structural member, the method may include blocking flow to the work cylinder and providing communication between the cap end of the energy storage cylinder and the accumulator, instituting a lower command and allowing gravity to lower the structural member while fluid flows from the cap end of the energy storage cylinder through the first control valve to the accumulator. Further, to raise the structural member, the method may include pumping flow from the main control valve to the cap end of the work cylinder, instituting a raise command and releasing flow from the accumulator, through the first control valve to the cap end of the energy storage cylinder.

In any one or more of the embodiments described above, the energy storage system may further comprise a pump and a third valve disposed between the cap end of the energy storage cylinder and the pump. When the first valve is at least partially closed and the second valve is at least partially closed and the third valve is at least partially open, at least a portion of the fluid from the pump is directed to the cap end of the energy storage cylinder.

In any one or more of the embodiments described above, the energy storage system may also include a fourth valve disposed between the first valve and the cap end of the energy storage cylinder. The fourth valve may provide selective communication between the rod and cap ends of the energy storage cylinder.

In any one or more of the embodiments described above, the energy storage system may further include a controller that is configured to receive pressure signals indicating the pressure at the rod end of the work cylinder and the pressure at the accumulator. When the structural member is being lowered, if the pressure at the rod end of the work cylinder is lower than a preset pressure threshold and if the pressure at the accumulator is lower than an equivalent load pressure, the controller is configured to maintain the first valve in an open position and the second valve in a closed position to direct fluid from the cap end of the energy storage cylinder to the accumulator.

In any one or more of the embodiments described above, the energy storage system may include a controller that is configured to detect when the pressure at the rod end of the work cylinder is higher than a preset pressure threshold and when the pressure at the accumulator is equal to or higher than an equivalent load pressure. When these conditions are met, the controller may be configured to open the second valve to provide communication between the cap end of the energy storage cylinder and the reservoir. The controller may be further configured to close the first valve thereby isolating the cap end of the energy storage cylinder from the accumulator.

In any one or more of the embodiments described above, the energy storage system may further include a controller that is configured to detect when the pressure at the cap end of the energy storage cylinder is higher than a preset pressure threshold and when the pressure at the cap end of the energy storage cylinder is higher than a calculated equivalent load pressure. When these conditions are met, the controller is configured to open the first valve, close the second valve and allow fluid from the cap end of the energy storage cylinder to pass through the first valve to the accumulator.

In any one or more of the embodiments described above, the system may further include a controller that is configured to detect when a pressure at the cap end of the energy storage cylinder is lower than a preset pressure threshold and when the pressure at the cap end of the energy storage cylinder is lower than a calculated equivalent load pressure. When those conditions are met, the controller may be further configured to open the third valve thereby providing communication between the pump and the cap end of the energy storage cylinder. The controller may be further configured to close the first valve thereby isolating the accumulator.

In any one or more of the embodiments described above, when the structural member is performing work in a lowered position, the first valve may be closed and the second valve may be opened to permit fluid to flow between the cap end of the energy storage cylinder and the reservoir thereby depressurizing the cap end of the energy storage cylinder without depressurizing the accumulator.

In any one or more of the embodiments described above, the structural member may be raised without using fluid from the accumulator. To accomplish this, the first valve may be closed thereby isolating the accumulator and the second valve may be closed to isolate the reservoir. The system may further include a third valve disposed between the pump and the first and second valves. The third valve may be opened to provide communication between the pump and the cap end of the energy storage cylinder.

In any one or more of the embodiments described above, a check valve may be used to prevent flow from the first valve to the third valve thereby directing flow to a fourth valve which, when open, provides selective communication between the first control valve and the cap end of the energy storage cylinder.

In any one or more of the embodiments described above, the fourth valve may also provide selective communication between the rod end and the cap end of the energy storage cylinder.

In any one or more of the embodiments described above, various pressure sensors may be included such as a first pressure sensor that is linked to the accumulator and the first valve. Further, a second pressure sensor may be included that may be linked to the cap end of the work cylinder and the main control valve. Further, in those embodiments that include a fourth valve disposed between the cap end and the rod end of the energy storage cylinder, the machine or system may include a third pressure sensor that is linked to the cap end of the energy storage cylinder and the rod end of the energy storage cylinder through the fourth valve. Further, the machine or system may include a fourth pressure sensor linked to the rod end of the work cylinder.

In any one or more of the embodiments described above, the structural member is a boom assembly.

In any one or more of the embodiments described above, the machine may be an excavator or a loader.

### BRIEF DESCRIPTION OF THE DRAWINGS

FIG. 1 schematically illustrates one example of an energy storage cylinder and control system wherein the valves are positioned to lower the structural member while transmitting pressurized fluid from the cap end of the energy storage cylinder to the accumulator.

FIG. 2 schematically illustrates the disclosed energy storage cylinder and control system wherein the valves are in a position to apply extra downward pressure or digging action after the structural member has been lowered.

FIG. 3 schematically illustrates the disclosed energy storage cylinder control system wherein the control are in a position to raise the structural member using the energy storage cylinder and pressurized fluid from the accumulator.

FIG. 4 schematically illustrates the disclosed energy storage cylinder control system wherein the valves are in a position to raise the structural member without using pressurized fluid from the accumulator.

### DETAILED DESCRIPTION

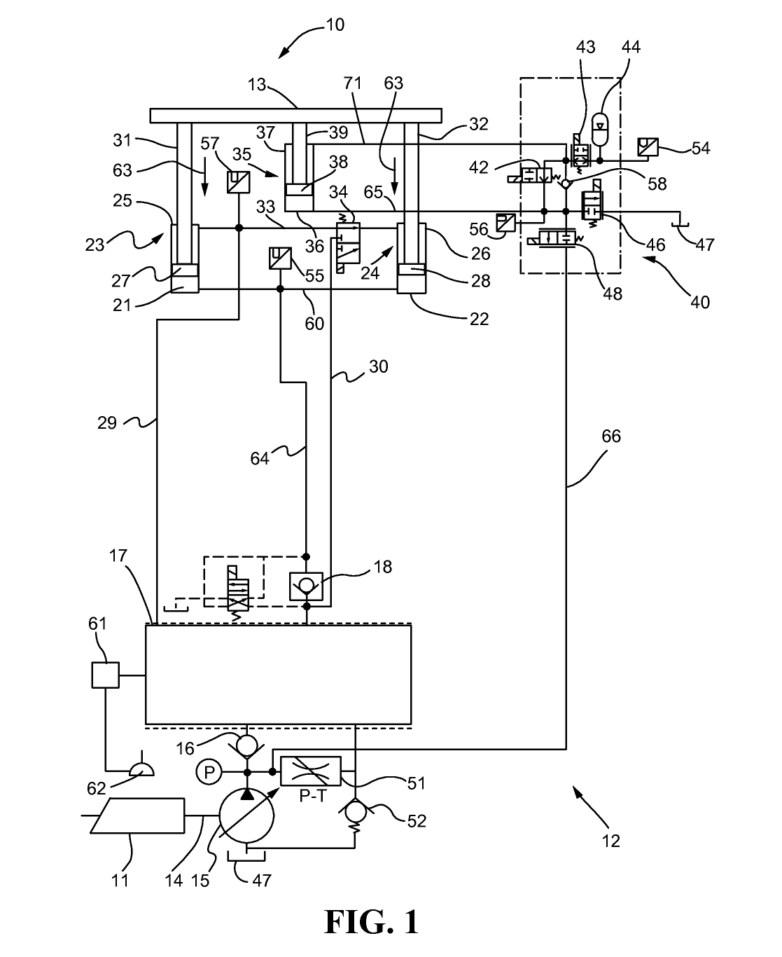

FIG. 1 schematically illustrates a machine 10 powered by a motor or engine 11 and equipped with a hydraulic system 12 that is used to raise, lower and manipulate a structural member 13. For example, the structural member 13 may be a boom assembly such as a combination boom, stick and bucket for an excavator or backhoe or the structural member 13 may be a carriage or bucket for a track or wheel loader. Other exemplary machines and applications for the disclosed hydraulic system 12 will be apparent to those skilled in the art.

FIG. 1 shows the motor or engine 11 (which may be electric or fossil fuel powered) that is coupled to a drive shaft 14 that drives a hydraulic pump 15, which may be a fixed or variable displacement motor. The pump 15 directs pressurized hydraulic fluid through a check valve 16 and through a main control valve 17. The main control valve 17 can be used to selectively deliver hydraulic fluid past a check valve 18 to one or more work actuators, such as cap ends 21, 22 of work cylinders 23, 24, respectively. The work cylinders 23, 24 also may include rod ends 25, 26 that are opposite the corresponding cap ends 21, 22. The work cylinders 23, 24 each may accommodate pistons 27, 28 which are coupled to rods 31, 32 which, in turn, may be coupled to the structural member 13.

The main control valve 17 may also selectively deliver fluid to the rod ends 25, 26 of the work cylinders 23, 24 as shown, via lines 29, 30 and directional control valve 34. The rod ends 25, 26 of the work cylinders 23, 24 are in communication with each other via a line 33 in fluid communication and intersecting line 29 and a directional control valve 34 when the valve 34 is in its normally open position as shown in FIG. 1.

In addition to the work cylinders 23, 24 (of which there may be only one as opposed to two or more), the system 12 may include an energy storage cylinder (ESC) 35 configured to facilitate storage and/or reuse of energy during lowering of the boom and recovery and/or reuse of energy during raising of the boom. The ESC 35 can include a cap end 36, a rod end 37 and a piston 38 disposed therebetween. The piston 38 may be coupled to an assist rod 39 which, in turn, may be coupled to the structural member 13. To facilitate the ESC 35 and its storage, recovery, and/or reuse of energy, the system 12 may also include an energy regulation circuit (ERC) 40. Part of the ERC 40 may be disposed between the cap end 36 and the rod end 37 of the ESC 35 to facilitate regeneration of flow therebetween. Part of the ERC 40 may also be disposed between the cap end 36 and the rod end 37 of the ESC 35 and an accumulator 44 to facilitate energy recovery and reuse. Part of the ERC 40 may be linked to the pump to direct pump flow to the ESC 35 in order to provide the ESC 35 with energy assist during raising of the boom or structural member 13.

For example, the cap end 36 of the ESC 35 may be in communication with a first valve 43 of the ERC. The first valve 43 may be in a normally open flow passing position, and may be a two way valve. The first valve 43 may be in communication with an accumulator 44 or other hydraulic energy storage device. The cap end 36 of the ESC 35 may also be in communication with a second valve 46 of the ERC 40 which, when open, provides communication between the cap end 36 and the reservoir 47. The cap end 36 of the ESC 35 may also be in communication with a third valve 48 of the ERC 40 that, when open, provides communication between the cap end 36 of the ESC 35 and the pump 15 via a valve 51. The third valve 48 may also be in communication with the reservoir 47 via a check valve 52. Finally, the ERC 40 may include a fourth valve 42 that provides selective communication between the rod end 37 and cap end 36 of the ERC 35. The fourth valve 42 may also provide selective communication between the first valve and the cap end 36 of the ERC 35. It can be appreciated by those skilled in the art that the ERC 40 may include various configurations and arrangements of one or more of the first, second, third, or fourth valves 42, 46, 48, 43 and any combination thereof.

The machine 10 may also be equipped with a plurality of sensors, four of which are shown in FIGS. 1-4. A first sensor 54 may be used to monitor the pressure in the accumulator 44. A second sensor 55 may monitor the pressure in the cap ends 21, 22 of the work cylinders 23, 24. A third sensor 56 may be used to monitor the pressure at the cap end 36 of the ESC 35 and/or the pressure of the fluid being delivered to the cap end 36 of the ESC 35 from the accumulator 44 via the second valve 43 and first valve 42. Finally, a fourth sensor 57 may be used to monitor the pressure at the rod ends 25, 26 of the work cylinders 23, 24. A check valve 58 can prevent fluid from the accumulator 44 from passing through the third valve 48 to the reservoir 47 and can direct flow from the accumulator 44 through the first and fourth valves 43, 42 as shown in FIG. 1.

The main control valve 17 may be linked to a controller 61 (that may be an engine control unit or ECU) which, in turn, may be linked to an operator input device, such as a joystick 62 or other mechanisms for initiating machine performance.

Still referring to FIG. 1, the structural member 13 can be lowered as indicated by the arrows 63. The main control valve 17 can be in a “hold” mode to block flow through a line 64 to the cap ends 21, 22 of the work cylinders 23, 24. Because the structural member 13 is being lowered, at least a portion of potential energy of the raised structural member 13 may be captured in the following way.

Specifically, the following valves can be de-energized: the fourth valve 42 (flow passing position), the first valve 43 (flow passing position), and the second and third valves 46, 48 (flow blocking positions). As the structural member 13 is lowered, pressurized fluid from the cap end 36 of the ESC 35 proceeds through a line 65 to a line 66 as it bypasses the open fourth valve 42 and proceeds past the check valve 58 and through the open first valve 43 to the accumulator 44. In this way, pressurized fluid from the cap end 36 of the ESC 35 is stored in the accumulator 44 and at least some of the potential energy of the raised structural member 13 is captured as the structural member 13 is lowered in the direction of the arrows 63. The configuration of the valves 43, 46, 48, 42 may be controlled by the controller 61 which de-energizes the corresponding valves if a lower command is detected by movement of the joystick 62 and the fourth sensor 57 detects a pressure at the rod ends 25, 26 of the work cylinders 23, 24 that is lower than predetermined pressure thresholds. Further, the first sensor 54 may also detect a pressure lower than a calculated equivalent load pressure based on the height and load of the bucket.

Therefore, in the lowering mode illustrated in FIG. 1, the controller may output a command to the main control valve 17 the controller 61 to lower and monitor the fourth pressure sensor 57 and maintain the valves 43, 46, 48 and 42 in their de-energized positions as shown in FIG. 1. The lowering of the structural member 13 is driven largely by gravity and pressure at the rod ends 25, 26 of the work cylinders 23, 24. Further, pressure in the rod end 37 of the ESC 35 may also assist in lowering the structural member 13 while pressurized fluid from the cap end 36 of the ESC 35 is stored in the accumulator 44 as potential energy.

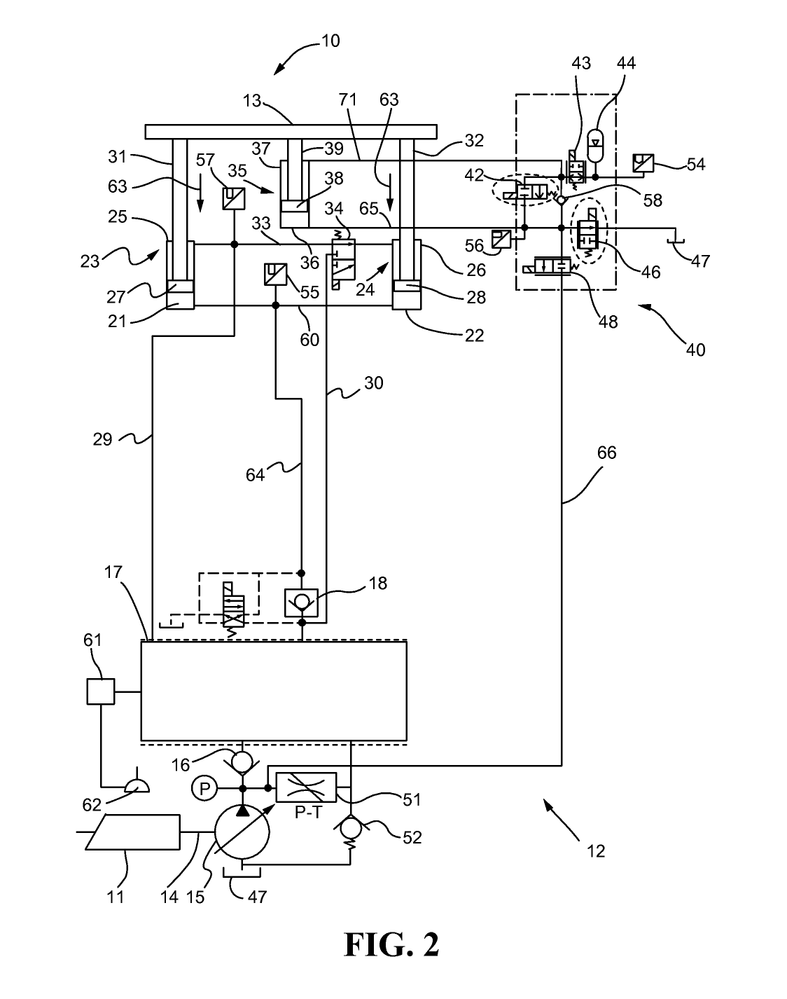

FIG. 2 illustrates a lowering of the structural member 13 with the energy storage functions illustrated in FIG. 1 being inactivated. Specifically, a command to lower the structural member 13 is inputted at the joystick or other input device 62. The fourth sensor 57 detects a pressure at the cap ends 25, 26 of the work cylinders 23, 24 that is higher than a preset pressure threshold. Further, the first sensor 54 detects a pressure equal to or higher than a calculated equivalent load pressure based on the current status of the bucket or work implement (not shown) that is coupled to the structural member 13. In this mode, when the structural member 13 is lowered without storing potential energy, the controller 61 may output a command to the main control valve 17 to release pressure from the cap ends 21, 22 of the work cylinders 23, 24 and to monitor the fourth pressure sensor 57. The controller 61 may also issue a command to open the second valve 46 thereby establishing communication between the cap end 36 of the ESC 35 and the reservoir 47. The controller 61 may also issue a command to close the fourth valve 42 in a controlled fashion for a smooth transition to cut off energy to the ESC 35. Using this mode, the structural member 13 may gain extra push down force from the ESC 35 as the cap end 36 of the ESC 35 is evacuated to the reservoir 47. The mode disclosed in FIG. 2 is effective for digging and other operations after the structural member 13 has been lowered to the ground level.

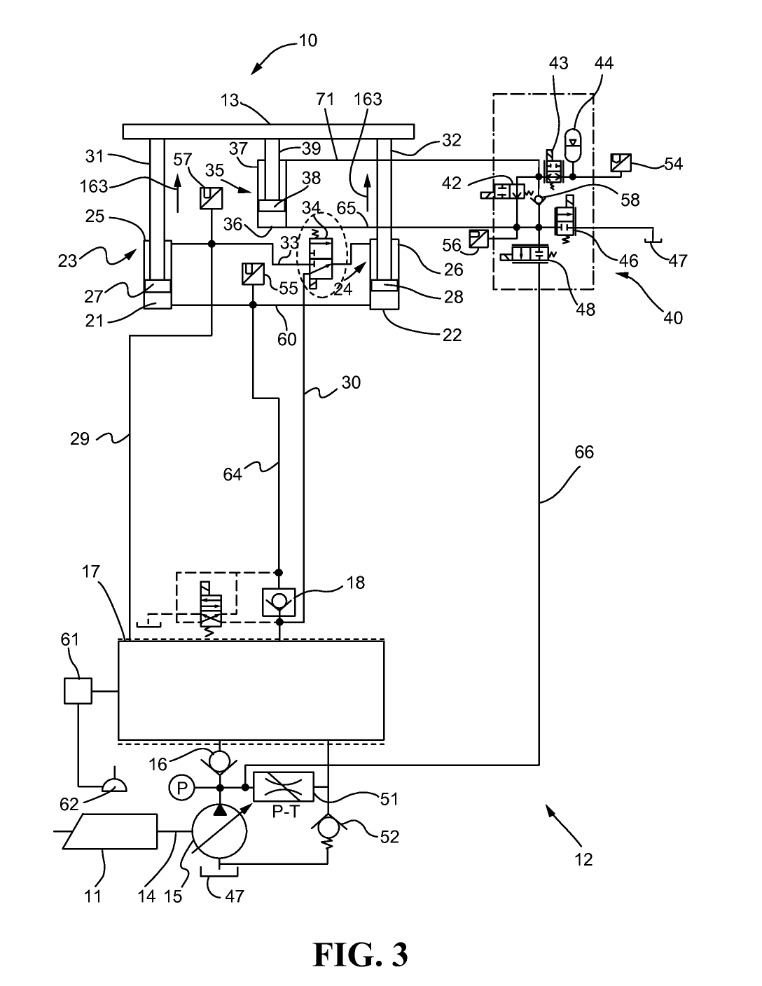

Turning to FIG. 3, the hydraulic system may be configured to raise the structural member 13 as indicated by the arrow 63. First, a raise command may be inputted at the joystick or other input means 62 and received at the controller 61. The controller 61 may also receive a reading from the third sensor 56 which, when raising the structural member 13 and with the fourth valve 42 open, the third sensor 56 may detect pressure at the rod end 37 of the ESC 35 that is higher than a predetermined pressure threshold. Further, the sensor 56 may detect a pressure higher than a calculated equivalent load pressure based on the current status of the work implement coupled to the structural member 13. In this mode, the controller 61 may output a command to the main control valve 17 to raise the structural member 13 and monitor the second pressure sensor 55 and the third pressure sensor 56. The controller 61 may also de-energize the fourth control valve 42, the first control valve 43, the second control valve 46 and the third control valve 48 as shown in FIGS. 1 and 3. The raising of the structural member 13 is driven by the hydraulic pump 15 which delivers fluid through the main control valve 17, past the check valve 18, through the line 64 to the cap ends 21, 22 of the work cylinders 23, 24. With the first control valve 43 and the fourth control valve 42 in de-energized or open positions, pressurized fluid may be delivered from the accumulator 44 to the cap end 36 of the ESC 35. The energy provided by the accumulator 44 to the ESC 35 may provide lift assistance and thus reduce the force necessary from the work cylinders 23, 24, meaning less flow and pressure are needed from the pump 15. To conserve pump flow, the work cylinders 23, 24 may be raised in a regeneration mode by energizing the directional control valve 34, which returns fluid from the rod ends 25, 26 of the work cylinders 23, 24 to the line 64 via the line 30.

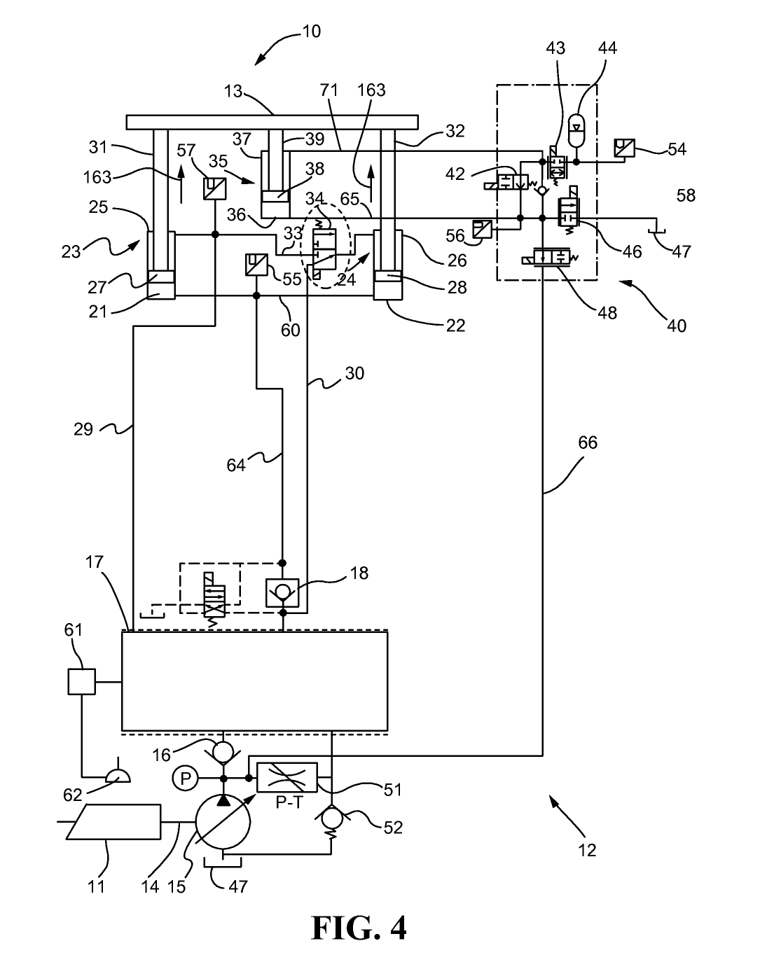

Finally, turning to FIG. 4, the hydraulic system 12 is illustrated in a mode where the structural member 13 can be raised while the accumulator 44 is isolated. First, a raise command may be inputted at the joystick or other input means 62. The third sensor 56 detects a pressure lower than a preset pressure threshold and a pressure lower than a calculated equivalent load based on the current status of the structural member 13 and the work implement. The controller 61 outputs a command to the main control valve 17 to raise the structural member 13 and the controller 61 monitors the pressure measured by the second pressure sensor 55 and the third pressure sensor 56. The controller 61 also sends a command to open the third valve 48 and close the first valve 43. Opening the third valve 48 and closing the first valve 43 provides communication between the pump 15 and the cap end 36 of the ESC 35. The controller may also send a command to leave the fourth and second valves 42 and 46 in de-energized open and closed positions respectively as shown in FIG. 4. A closed second valve 46 blocks communication between the reservoir 47 and the cap end 36 of the ESC 35. As the structural member 13 is raised by pressure delivered by the hydraulic motor or pump 15, fluid from the rod end 37 of the ESC 35 may be directed through the line 71, past the closed first valve 43 and through the open fourth valve 42, through the line 65 to the cap end 36 of the ESC 35. The cap end 36 of the ESC 35 may also be supplied with fluid from the pump 15 via the line 66, the open third valve 48, the line 65 and the closed first and third valves 43, 46.

In summary, four modes of operation of the hydraulic system 12 are illustrated in FIGS. 1-4. In FIG. 1, which is a boom holding position, the main control valve 17 is in a “hold” mode and blocks flow to the cylinders 23, 24. When in the “hold” mode illustrated in FIG. 1, the controller 61 is configured to de-energize the first through fourth valves 43, 46, 48 and 42 as illustrated in FIG. 1. When the operator moves the joystick 62 to lower the boom, a signal is sent to the controller 61 along with a signal from the sensor 57 that the pressure is lower than a preset pressure threshold along with a signal from the sensor 54 that the pressure is lower than a calculated equivalent load pressure. In other words, the lowering of the boom or structural member 13 is instigated at the joystick 62 and the pressure at the rod ends 25, 26 (as measured by the sensor 57) is lower than preset pressure thresholds and the pressure at the rod end 37 of the ESC 35 is also lower than the calculated equivalent load pressure. Thus, the boom is lowered. In this mode, the controller 61 is configured to monitor the pressure sensor 57, maintain the valves 43, 46, 48 and 42 in their de-energized positions (valves 42 and 43 in open positions; valves 46 and 48 in closed positions). The lowering of the boom is driven by gravity and the reduced pressure at the rod ends 25, 26 of the cylinders 23, 24. The fluid departing the rod end 37 of the ESC 35 is stored in the accumulator 44.

FIG. 2 illustrates a mode where the boom 13 is lowered with the energy saving function turned off. Specifically, a boom lower command is initiated at the joystick 62 and detected by the controller 61. The sensor 57 detects a pressure that is higher than preset pressure thresholds. Further, the sensor 54 detects pressure equal to or higher than the calculated equivalent load pressure. In the mode illustrated in FIG. 2, the controller 61 may be configured to initiate a monitoring of the pressure sensor 57 and the controller 61 may open the second valve 46 and close the fourth valve 42 as shown in FIG. 2. Opening the second valve 46 and closing the fourth valve 42 provides a smooth transition to cut off energy to the ESC 35. By applying the control mode illustrated in FIG. 2, the structural member 13 gains extra pull down force from the ESC 35 as fluid from the cap end 36 proceeds through the line 65 and through the open second valve 46 to the reservoir 47. As a result, the ESC 35 increases the lowering speed.

Returning to FIG. 3, a boom raise mode is illustrated. A signal to raise the boom is initiated at the joystick 62. Then, the controller 61 monitors the sensor 56 for a pressure that is higher than a preset pressure threshold and a pressure that is higher than the calculated equivalent load pressure. These values indicate that there is sufficient energy in the ESC 35 that is worth recovering or saving. Therefore, in the mode illustrated in FIG. 3, the controller 61 may maintain the first valve 43 in an open position (providing access to the accumulator 44), the fourth valve 42 in an open position (providing communication between the ESC 35 and accumulator 44), the second valve 46 in a closed position (isolating the reservoir 47) and the third valve 48 in a closed position (thereby isolating the ESC 35 from the pump 15). The boom 13 is raised by pressurized fluid provided to the cap ends 21, 22 of the cylinders 23, 24 by the pump 15 via the check valve 18, the line 64 and the line 60. The boom 13 is also raised by pressurized fluid in the cap end 36 of the ESC 35 which may be provided by the accumulator 44, through the open first valve 43, through the open fourth valve 42, through the line 65 to the cap end 36 of the ESC 35. Thus, in the mode illustrated in FIG. 3, the stored energy in the accumulator 44 is used to raise the boom 13 as the fluid is released from the accumulator 44 to the ESC 35.

Finally, turning to FIG. 4, the mode being illustrated is a boom 13 raise mode with the accumulator 44 off or isolated. Again, the raise command may be initiated at the joystick 62 and the controller 61 receives a signal from the sensor 56 that the pressure at the cap end 36 of the ESC 35 is lower than the preset pressure thresholds and that the pressure is lower than the calculated equivalent load pressure. Because of the low pressures detected by the sensor 56, the accumulator 44 may be isolated and the first valve 43 may be closed. Further, the second valve 46 may be closed to isolate the reservoir 47. The fourth valve 42 may remain open so that fluid from the rod end 37 of the ESC 35 may be circulated through the line 71, fourth valve 42 and line 71 to the cap end 36 of the ESC 35. The third valve 48 may be opened thereby providing communication between the pump 15 and the cap end 36 of the ESC 35 due to the closure of the valves 46 and 43. Thus, the boom 13 may be raised by providing pressurized fluid from the pump 15 to the cap ends 21, 22 of the cylinders 23, 24 via the lines 59, 60 and further fluid is provided to the cap end 36 of the ESC 35 from the pump 15 via the line 66 through the open third valve 48 and through the line 65 (with the valves 43 and 46 closed).

### INDUSTRIAL APPLICABILITY

An extra hydraulic cylinder, or an energy storage cylinder (ESC) is added to one or two standard working cylinders in a hydraulic system for a machine such as a hydraulic excavator or loader. The system uses the extra cylinder to control fluid movement during the boom raise and lower functions and store fluid pressure in an accumulator. The stored fluid pressure in the accumulator may be reused when the energy is needed, such as raising the boom at a later time or the stored fluid may provide additional downward pressure during digging, tamping or fast lowering operations. The energy storage functions may be selectively disconnected during a raise or a lower operation.

The system features a valve arrangement and a control system to selectively disconnect the energy recovery circuit during a boom lower operation for a faster lowering speed or the energy recovery circuit may be left on during the boom lowering operation to restore potential energy. The energy recovery circuit may also be disconnected during a boom raise operation to rely upon pump pressure or it may be turned on to reuse stored energy in the accumulator. The disclosed valve arrangement and control system may selectively connect the pump or hydraulic motor to the accumulator during a boom raise operation.

What is claimed is:

1. An energy storage system for assisting in vertically moving a structural member, the system comprising:
at least one work cylinder to vertically move the structural member;
an energy storage cylinder coupled to the structural member, including a rod end and a cap end, wherein the rod end and the cap end are in selective fluid communication;
an accumulator;
a fluid reservoir;
a first valve disposed between the accumulator and the cap end of the energy storage cylinder, a second valve disposed between the fluid reservoir and the cap end of the energy storage cylinder;
wherein, when the structural member is lowered and the first valve is at least partially open and the second valve is at least partially closed, at least a portion of the fluid from the cap end of the energy storage cylinder is directed to the accumulator; and
wherein, when the structural member is raised and the first valve is at least partially open and the second valve is at least partially closed, at least a portion of fluid from the accumulator is directed to the cap end of the energy storage cylinder.

2. The energy storage system of claim 1, further comprising a pump and a third valve disposed between the cap end of the energy storage cylinder and the pump, wherein when the first valve is at least partially closed and the second valve is at least partially closed and the third valve is at least partially open, at least a portion of fluid from the pump is directed to the cap end of the energy storage cylinder.

3. The energy storage system of claim 1, further comprising a fourth valve disposed between the first valve and the cap end of the energy storage cylinder.

4. The energy storage system of claim 1, further comprising a controller that is configured to receive pressure signals indicating the pressure at the rod end of the at least one work cylinder and the pressure at the accumulator when the structural member is being lowered,
wherein, if the pressure at the rod end of the at least one work cylinder is lower than a preset pressure threshold and if the pressure at the accumulator is lower than an equivalent load pressure, the controller is configured to maintain the first valve in an open position and the second valve in a closed position to thereby direct fluid from the cap end of the energy storage cylinder to the accumulator.

5. The energy storage system of claim 1, further comprising a controller that is configured to detect when a pressure at the rod end of the at least one work cylinder is higher than a preset pressure threshold and when the pressure at the accumulator is equal to or higher than an equivalent load pressure when the structural member is being lowered;
the controller is also configured to open the second valve to provide communication between the cap end of the energy storage cylinder and the reservoir, and the controller is configured to close the first valve thereby isolating the cap end of the energy storage cylinder from the accumulator.

6. The energy storage system of claim 1, further comprising a controller that is configured to detect when a pressure at the cap end of the energy storage cylinder is higher than a preset pressure threshold and higher than a calculated equivalent load pressure, the controller is configured to open the first valve, close the second valve, and allow fluid from the cap end of the energy storage cylinder to pass through the first valve into the accumulator.

7. The energy storage system of claim 2, further comprising a controller that is configured to detect when a pressure at the cap end of the energy storage cylinder is lower than a preset pressure threshold and lower than a calculated equivalent load pressure,
the controller is further configured to open the third valve thereby providing communication between the pump and the cap end of the energy storage cylinder, the controller is further configured to close the first valve thereby isolating the accumulator.

8. The system of claim 1 wherein, when the structural member is performing work in a lowered position, the first valve is closed and the second valve is opened to permit fluid flow between the cap end of the energy storage cylinder and the reservoir thereby depressurizing the cap end of the energy storage cylinder without depressurizing the accumulator.

9. The system of claim 1 wherein, when the structural member is raised without using fluid from the accumulator, the first valve is closed thereby isolating the accumulator, the second valve is closed to isolate the reservoir and a third valve disposed between the pump and the first and second valves is opened to provide communication between the pump and the cap end of the energy storage cylinder.

10. The system of claim 2 wherein a check valve prevents flow from the first valve to the third valve thereby directing flow to a fourth valve, which when open, provides communication between the first valve and the cap end of the energy storage cylinder.

11. A machine that raises and lowers a structural member, the machine comprising:
a work cylinder including a rod end, a cap end, a piston disposed therebetween and a rod coupling the piston to the structural member;
the cap end and rod end of the work cylinder in communication with a main control valve for raising or lowering the structural member;
an energy storage cylinder including a rod end, a cap end and a piston disposed therebetween, the piston connected to an assist rod that is coupled to the structural member;
the cap and rod ends of the energy storage cylinder in communication with a first valve disposed between the energy storage cylinder and an accumulator and a second valve disposed between the energy storage cylinder and the reservoir;
the rod end of the energy storage cylinder in selective communication with the cap end of the energy storage cylinder;
wherein, when the structural member is lowered, fluid flows from the cap end of the energy storage cylinder, through the first valve to the accumulator; and
when the structural member is raised, fluid flows from the accumulator to the cap end of the energy storage cylinder through the first valve.

12. The machine of claim 11 wherein, when the structural member is performing work in a lowered position, the second control valve is opened to permit fluid to flow between the cap end of the energy storage cylinder and the reservoir.

13. The machine of claim 11 wherein, when the structural member is raised without fluid from the accumulator, the first control valve is closed thereby isolating the accumulator, the second control valve is closed to isolate the reservoir and a third control valve is opened to provide communication between the pump and the cap end of the energy storage cylinder.

14. The machine of claim 13 wherein a first pressure sensor is linked to the accumulator and the first valve.

15. The machine of claim 14 wherein a second pressure sensor is linked to the cap end of the work cylinder and the main control valve.

16. The machine of claim 15 further including a fourth valve disposed between the cap end and rod end of the energy storage cylinder and, wherein a third pressure sensor is linked to the cap end of the energy storage cylinder and the rod end of the energy storage cylinder through the fourth valve.

17. The machine of claim 16 further including a fourth pressure sensor linked to the rod end of the work cylinder.

18. The machine of claim 11 wherein the structural member is boom assembly.

19. The machine of claim 11 wherein the machine is an excavator or a loader.

20. A method of controlling a raising and a lowering of a structural member, the method comprising:
providing a work cylinder including a rod end, a cap end, a piston disposed therebetween and a rod coupling the piston to the structural member, the cap end and rod end of the work cylinder in communication with a main control valve for raising or lowering the structural member;
providing an energy storage cylinder including a rod end, a cap end and a piston disposed therebetween, the piston connected to an assist rod that extends out the rod end and is coupled to the structural member, the cap and rod ends of the energy storage cylinder in communication with a first valve that provides selective communication between the energy storage cylinder and an accumulator;
wherein, to lower the structural member, the method includes
blocking flow to the work cylinder and providing communication between the cap end of the energy storage cylinder and the accumulator;
instituting a lower command; and
allowing gravity to lower the structural member while fluid flows from cap end of the energy storage cylinder through the first control valve to the accumulator; and
wherein, to raise the structural member, the method includes
pumping flow from the main control valve to the cap end of the work cylinder;
instituting a raise command; and
releasing flow from the accumulator, through the first control valve, to the cap end of the energy storage cylinder.
